(19) United States
(12) Patent Application Publication
(10) Pub. No.: US 2026/0270606 A1
(43) Pub. Date: Sep. 10, 2026

(54) MULTI-LAYER SPEAKER ASSEMBLY

(71) Applicant: Cardo Systems, Ltd., Ra’anana (IL)

(72) Inventors: Gerhard Rudolf Pfaffinger, Ra'anana (IL); Markus Ewald Christoph, Ra'anana (IL)

(73) Assignee: Cardo Systems, Ltd., Ra’anana (IL)

(21) Appl. No.: 19/557,922

(22) Filed: Mar. 5, 2026

Related U.S. Application Data
(60) Provisional application No. 63/767,341, filed on Mar. 5, 2025.

(51) Int. Cl. H04R 1/10; H04R 1/28; H04R 1/34

(52) U.S. Cl. CPC H04R 1/1083; H04R 1/1008; H04R 1/2803; H04R 1/345; H04R 2460/01

(57) ABSTRACT

A speaker assembly includes a polymer ring structure having a first surface, a second surface, a cylindrical wall extending between the first surface and the second surface, and an opening extending through the first surface and defining a cylindrical inner region. The speaker assembly also includes a speaker grille attached to a front side of a speaker. The second surface of the polymer ring structure is coupled to the speaker grille to form an acoustic seal between the speaker grille and the polymer ring structure.

### CROSS-REFERENCES TO RELATED APPLICATIONS

This application claims the benefit of priority to U.S. Provisional Patent Application No. 63/767,341, filed Mar. 5, 2025, the entirety of which is hereby incorporated by reference herein.

### TECHNICAL FIELD

The present application generally relates to a speaker assembly for a helmet, and more specifically relates to a multi-layer speaker assembly.

### BACKGROUND

Many types of helmets, such as sports and safety helmets, including motorcycle helmets, all-terrain vehicle helmets, skiing helmets, fire brigade helmets, and military and police helmets may include acoustic components such as speakers and/or microphones. Such acoustic components, in combination with other hardware and/or software components, may be used to provide communication systems and audio playback to the wearer. In some cases, audio hardware and software components may be used to provide active noise cancellation to attenuate the volume of external noises, such as wind noise, engine noise, etc. In-helmet audio systems may be integrated into helmets by the helmet manufacturer or may be sold as after-market products to be installed by or for the helmet wearer.

Due to inherent size and space constraints, the size of a speaker that may be mounted within a helmet is necessarily limited. The proximity of the speaker to the user's ear requires careful consideration of acoustic properties and wearer comfort. A bulky and/or overly rigid speaker assembly will put too much pressure against the wearer's ear and will be uncomfortable for sustained use. A speaker assembly that does not couple well with the user's ear canal will be prone to poor acoustic performance.

### BRIEF SUMMARY

Various examples relating to a multi-layer speaker assembly and a helmet including such a multi-layer speaker assembly are described. One example multi-layer speaker assembly includes a soft polymer ring structure. One surface of the polymer ring structure acoustically couples to the front side of the speaker, i.e., the side of the speaker from which sound is emitted. A second surface of the polymer ring structure deforms to the contours of the user's ear when in contact with the user's ear for improved acoustic sealing and comfort. A cylindrical inner region of the polymer ring structure acts as a waveguide between the front side of the speaker and the user's ear. In some embodiments, the polymer is acoustically opaque, thus providing passive noise reduction due to blocking sound waves other than those emitted from the speaker from entering the cylindrical inner region of the polymer ring and passing to the user's ear.

In more detail, the polymer ring structure includes a first surface, a second surface, a cylindrical wall extending between the first surface and the second surface, and an opening. In some examples, a circumference of the cylindrical wall may be smaller than a circumference of the second surface. The opening extends through the first surface, the cylindrical wall and the second surface to define the cylindrical inner region of the polymer ring structure. The speaker assembly also includes a speaker grille attached to the front side of a speaker. In some examples, the circumference of the speaker with the speaker grille attached may be smaller than the circumference of the first surface but larger than the cylindrical inner region. The second surface of the polymer ring structure is coupled to the speaker grille forming a seal between the speaker grille and the polymer ring structure to acoustically seal the front side of the speaker within the cylindrical inner region. For instance, to couple the second surface to the speaker grille, the second surface can include a raised lip extending from the second surface. The raised lip can be positioned around an outer circumference of the speaker grille to form the acoustic sealing. In some examples, the raised lip can have a circumference larger than the cylindrical inner region. As another example, the polymer ring structure may not include a raised lip. In those cases, acoustic sealing between the polymer ring structure and the speaker grille may be formed by adhering the polymer ring structure to the speaker grille using an adhesion mechanism (e.g., glue, tape (single or double sided), etc.), where the second surface of the polymer ring structure is adhered to the front surface of the speaker grille.

The first surface of the polymer ring structure compresses against and deforms to the shape of the pinna of the user's ear when in contact with the user's ear. The acoustic sealing between the second surface and the speaker grille in combination with the first surface compressing against the pinna of the user's ear thus forms, in the cylindrical inner region, a waveguide between the front side of the speaker and the user's ear canal. In some examples, the speaker assembly further includes an acoustically transparent material, such as a thin foam layer, covering the first surface of the polymer ring structure. The thin foam layer avoids direct contact between the user's skin and the first surface of polymer ring structure, to increase comfort and reduce or avoid sweating.

In some examples, the speaker assembly also includes a foam ring surrounding and abutting an outer portion of the cylindrical wall between the first surface and the second surface of the polymer ring structure. The foam ring may provide added structural support between the first surface of the polymer ring structure and the second surface of the polymer ring structure when the first surface of the polymer ring structure compresses against the user's ear.

The speaker assembly may further include a foam insert positioned inside the cylindrical inner region of the polymer ring structure and circumferentially abutting against an inner portion of the cylindrical wall. In examples including the foam insert, the foam insert may be coupled to the speaker grille using an adhesive or other suitable coupling mechanism. Further, the polymer ring structure may be characterized by a first acoustic impedance and the foam insert may be characterized by a second acoustic impedance less than the first acoustic impedance. In some examples, the foam ring surrounding the outer portion of the cylindrical wall of the polymer ring structure is characterized by an acoustic impedance that is less than an acoustic impedance of the polymer ring structure and less than an acoustic impedance of the foam insert.

In some examples, the speaker grille includes at least one microphone mounted to the speaker grille and configured to detect ambient noise present in the cylindrical inner region of the polymer ring structure. In some examples, the at least one microphone is mounted on an underside portion of the speaker grille and positioned between the speaker and the speaker grille.

The speaker assembly also includes or can be connected to a controller, which is communicatively coupled to the microphone and the speaker and configured to receive sound wave information associated with the noise detected by the microphone and to execute signal processing instructions to generate audio playback signals through the speaker for active cancellation of the noise. In some examples, rather than complete active cancellation of the noise, the controller may be configured to perform active noise reduction and/or active noise control of the noise by blocking certain types of noise signals (e.g., low frequency wind noise) while permitting propagation of other types of noise signals (e.g., higher frequency traffic noises, sirens, etc.). In some examples, the controller is integrated with an external computing device, such as a mobile phone. In such embodiments, the controller may be communicatively coupled to the at least one microphone and the speaker via a Bluetooth® connection, for example. Other wireless or wired connections between the controller, the at least one microphone, and the speaker are possible.

The above-described speaker assembly configurations may be implemented inside a helmet. According to yet another example, a helmet includes an outer protective shell and an interior protective layer. A speaker pocket is formed in the interior protective layer and a speaker assembly is positioned within the speaker pocket. The speaker pocket may comprise a recessed region of the innermost protective layer (e.g., EPS foam layer) surrounded by an opening or hole in a padding layer that covers the innermost protective layer. In some examples, the speaker assembly may be fixedly attached to the helmet inside the speaker hole, e.g., using a suitable adhesive. In other examples, the speaker assembly may be detachable or removable from the recessed region of the interior protective layer. For example, the speaker assembly may be removably secured within the speaker pocket by way of a press-fit or form fit or using Velcro or other temporary attachment mechanism. In any case, the speaker assembly may be positioned within the speaker pocket of the interior protective layer such that the first surface of the polymer ring structure is flush or substantially flush with the surface of the interior protective layer that contacts the user's ear. In this manner, the first surface of the polymer ring structure compresses against the user's ear when the user wears the helmet, which contributes to formation of the acoustic waveguide inside the cylindrical inner region of the polymer ring between the speaker assembly and the user's ear.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example of a helmet and a speaker assembly positioned within its inner protective layer, according to certain embodiments.

FIG. 2 shows an example of a speaker and speaker grille, according to certain embodiments.

FIG. 3A shows a perspective view of a polymer ring structure, according to certain embodiments.

FIG. 3B shows a cross-sectional side view of the polymer ring structure of FIG. 3A, according to certain embodiments.

FIG. 4 shows a cross-sectional side view of a multi-layer speaker assembly, according to certain embodiments.

FIG. 5A shows a front perspective view of a multi-layer speaker assembly, according to certain embodiments.

FIG. 5B shows a back perspective view of the multi-layer speaker assembly FIG. 5A, according to certain embodiments.

FIG. 5C shows a side view of a multi-layer speaker assembly positioned within an inner protective layer, according to certain embodiments.

FIG. 5D shows a side view of a multi-layer speaker assembly positioned within an inner protective layer, according to certain embodiments.

FIG. 6 shows an exploded view of a multi-layer speaker assembly, according to certain embodiments.

FIG. 7 shows an example arrangement of various components making up an in-helmet audio system, according to certain embodiments.

### DETAILED DESCRIPTION

Examples are described herein in the context of a multi-layer speaker assembly. Those of ordinary skill in the art will realize that the following description is illustrative only and is not intended to be in any way limiting. Reference will now be made in detail to implementations of example embodiments as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

Speaker assembly designs, such as those often incorporated into helmets, include a sound generating element, which may comprise a moving and/or bending diaphragm or membrane and other electrical components. Speaker assemblies used in helmets comprise a front side that is intended to face the ear of a listener or wearer (hereinafter “user”) of the helmet such that sound generated by the speaker is projected towards the ear of the user. Some speaker assembly designs also include a sound receiving element, such as one or more microphones. The sound receiving element is commonly placed on or near the front side of the speaker assembly such that sound generated by the user or otherwise present in the helmet (i.e., the user's voice or ambient noise) is received by the sound receiving element.

A helmet, in particular a full-face helmet, a three-quarter helmet, and/or a closed helmet where the entire head and ear portions are covered includes one or more interior protective layer(s). The interior protective layer(s) of the helmet typically include an expanded polystyrene (EPS) layer and one or more softer padding layer(s). The interior protective layer(s) may in some cases be shaped or configured to accommodate the multi-layer speaker assembly disclosed herein such that the front side of the speaker assembly is positioned adjacent to the user's ear. For example, a portion of the EPS layer may be shaped to include a recess that forms a rear chamber or a back wall of a speaker pocket formed in a cheek pad layer into which the multi-layer speaker assembly may be placed in a permanent or removably manner.

According to one particular example, a multi-layer speaker assembly is provided that is fitted into a speaker pocket formed in the interior protective layer(s) of a helmet. The described multi-layer speaker assembly provides a low-profile design with improved acoustic properties as well as improved comfort for the user. The multi-layer speaker assembly includes a speaker, a speaker grille attached to a front side of the speaker, and a polymer ring structure attached to the speaker grille. The polymer ring structure is formed from a nonpermeable material, such as silicone, rubber, coated fabric, leather (e.g., protein leather), or any other thin, soft, and acoustically nonpermeable material. A surface of the polymer ring structure is coupled to the speaker grille (using glue, a raised lip, etc.), and the polymer ring structure includes a cylindrical wall that extends between the surface contacting the speaker grille and a distal surface located in a direction towards the ear of the user. As described above, different mechanisms may be used to couple the polymer ring structure to the speaker grille. In example multi-layer speaker assemblies including a raised lip, the raised lip is formed on the surface of the polymer ring structure that contacts the speaker grille is sized such that the raised lip has a circumference that surrounds and abuts against an outer circumference of the speaker grille thereby forming an acoustic seal. In example multi-layer speaker assemblies that do not include a raised lip, the surface of the polymer ring structure can be adhered to the speaker grille (using, for example, glue) thereby forming the acoustic seal.

Formation of the acoustic seal in combination with the nonpermeable material of the polymer ring structure enables formation of an acoustic waveguide in the cylindrical inner region. In other words, the polymer ring structure acts as an acoustic waveguide by directing propagation of sounds waves generated by the speaker along a specific path through the cylindrical inner region from the speaker to the ear of the user. The acoustic waveguide enables control over the direction and intensity of the sound waves, preventing dispersion and improving clarity in the audio signals for the user. In addition, the distal surface of the polymer ring structure, which may compress against the user's ear when the user wears the helmet, provides additional acoustic sealing and contributes to formation of the acoustic waveguide inside the cylindrical inner region of the polymer ring.

The above-described multi-layer speaker assembly can include additional features and functionality to further improve the performance of in-helmet audio systems. For instance, a variety of foam structures may be incorporated into the multi-layer speaker assembly. More specifically, a foam ring can be included in the multi-layer speaker assembly, where the foam ring is positioned around an outer portion of the polymer ring structure. In addition, a foam insert may be positioned inside the cylindrical inner region of the polymer ring structure (i.e., inside the acoustic waveguide) and attached to either the speaker grille or an inner portion of the cylindrical wall using a friction fit or an adhesive.

The foam structures provide a variety of benefits to the multi-layer speaker assembly. For example, the foam ring that surrounds and abuts an outer portion of the cylindrical wall provides structural support between the surface contacting the speaker grille and the distal surface of the polymer ring structure. The added structural support may provide improved comfort to the user. Changing the type of foam material can provide for greater or lesser compression of the polymer ring structure when in use. In addition, the foam ring can also have the added benefit of preserving the acoustic waveguide by blocking (i.e., absorbing) undesirable low frequency sounds from entering the acoustic waveguide. The foam ring can also serve as an added physical barrier to protect the polymer ring structure from debris that a user may encounter during use of the helmet, such as rainwater, snow, salt spray, bugs, and the like. Similarly, the foam insert provides physical protection benefits such as protecting the sound generating element of the speaker (i.e., the membrane) from particles falling through the speaker grille (which may otherwise cause undesirable rattling if particles are trapped on top of the sound generating element).

Inclusion of the foam insert also provides improved acoustic performance for in-helmet audio systems. For instance, in helmet audio systems incorporating ANC functionality, the speaker assembly may further include at least one microphone (e.g., a reference and/or error microphone). The microphone may be installed on the speaker grille, and a controller may be communicatively coupled (e.g., through a wireless (e.g., Bluetooth®) connection or a wired connection) to the microphone and the speaker of the multi-layer speaker assembly. The microphone receives acoustic signals and transmits such signals or representations of them to the controller, which executes audio processing instructions and/or ANC instructions for audio playback and/or ANC using the speaker. ANC audio systems typically rely on a known transfer function between the input sound signal detected from the microphone and the resulting sound produced by the speaker to “cancel” out the detected sound (i.e., creating an anti-phase cancellation effect and/or anti-phase control effect). A primary path of the known transfer function typically refers to the acoustic transfer function between the reference microphone, which is configured to detect noise, for example, ambient noise, and the error microphone, which measures residual noise after the anti-phase cancellation signal is produced. A secondary path of the known transfer function typically refers to the acoustic transfer function between the speaker, which generates the anti-phase cancellation signal, and the error microphone.

The foam insert enables improved ANC outcomes. In particular, the foam insert can provide improvements to the phase response of the secondary path. The foam(s) employing a defined acoustic impedance improve a low frequency portion of the secondary path (i.e., the transfer function between the speaker and the error microphone) in such a way that the phase frequency response of the secondary path, particularly at low frequencies, is smoother and less dynamic. Smoothing of the secondary path phase frequency response leads to an improved ANC performance, especially in the bass region. In addition, the inventors have determined that the denser the foam(s) (i.e., foam(s) with a higher acoustic impedance) the better (i.e., shallower, flatter, less dynamic, smoother) the secondary path phase frequency response. However, higher density foam(s) can result in a negative impact to in-helmet audio systems in terms of comfort. As a result, in some examples of the multi-layer speaker assembly, the foam insert can include multiple layers such as two separate layers of foam each having different densities, where a first layer of the foam insert installed directly at the speaker grille is denser than a second layer of the foam insert installed inside the acoustic waveguide (e.g., directed to the user's ear). The second layer of the foam insert, having a lower density, provides a higher degree of comfort for the wearer. Additionally, an acoustically transparent material (e.g., a sound permeable cloth) may cover the surface of the polymer ring structure that contacts the ear of the user to provide added comfort (e.g., cushion) to the user.

The foregoing illustrative example is given to introduce the reader to the general subject matter discussed herein and the disclosure is not limited to this example. The following sections describe various additional non-limiting examples and embodiments of a multi-layer speaker assembly.

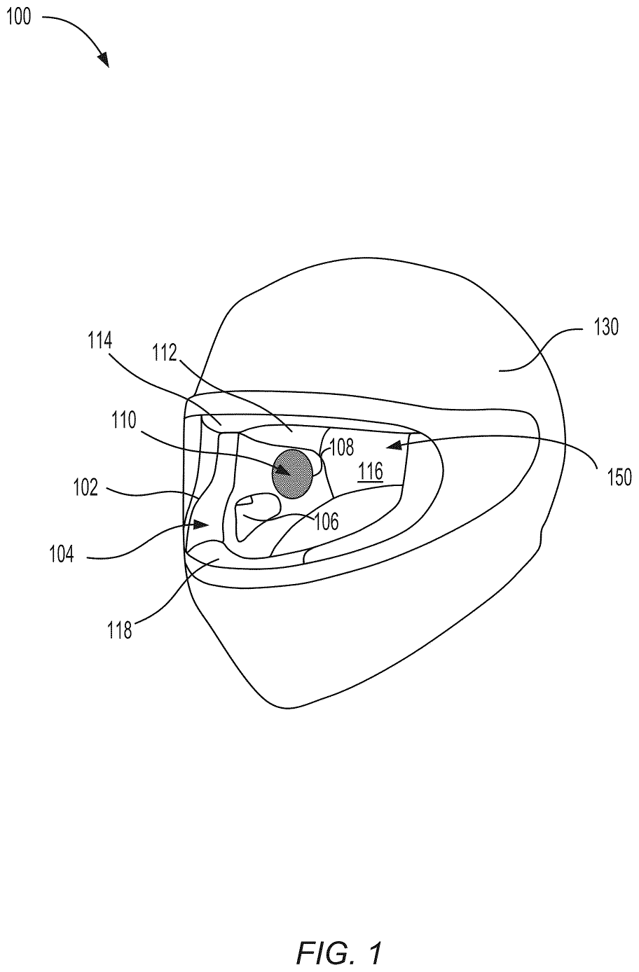

FIG. 1 shows an example of a helmet 100, according to certain embodiments disclosed herein. The helmet 100 comprises an outer shell 130 and one or more protective layers 104 mounted internally inside the helmet 100. The helmet 100 may be any variety of helmet capable of accommodating one or more interior protective layer 104. As general illustrative examples, the helmet 100 may for instance be a motorcycle helmet, bike helmet, racing helmet, or firefighter helmet, including full-face, three-quarter, closed helmets, or any modifications or alternatives thereof. An interior space 150 of the helmet 100 is shown adjacent the interior facing side of the protective layer 104.

Helmets, such as helmet 100, often comprise multiple interior protective layers 104 configured for mechanical impulse damping in the case of an accident. Frequently, one such interior protective layer 104 is comprised of an EPS foam layer. Although the present disclosure often refers to the interior protective layer 104 as being comprised of or including EPS, those skilled in the art will appreciate that different materials may be utilized instead without deviating from the basic idea of the invention. The interior protective layers 104 may also include additional layer(s) of padding positioned over the EPS layer. In some helmet designs, the additional padding layer(s) are provided in sections or separate pieces, which may be individually removed and/or replaced.

In FIG. 1, additional padding layer(s) include a “cheek piece” 102 (also referred to as a cheek pad), a temple piece 112, a front piece 114, a rear piece 116, and a chin piece 118. Other sections of the protective layer 104 cannot be seen in this particular view. The cheek piece 102 includes a chinstrap channel 106 and a hole or opening forming a speaker pocket 108. In some examples, the hole or opening through the cheek piece 102 leads to the EPS layer, which forms the back wall of the speaker pocket 108. In some cases, a recess may be provided in the EPS layer behind the opening in the cheek piece to accommodate the speaker assembly. The speaker pocket 108 of FIG. 1 is shown as being adjacent to the right ear of a user of the helmet 100. However, in other examples, the speaker pocket 108 may be formed on the opposite side (i.e., the left side) of the helmet 100. In some examples, a speaker pocket 108 may be included on both the left side and the right side of the helmet 100.

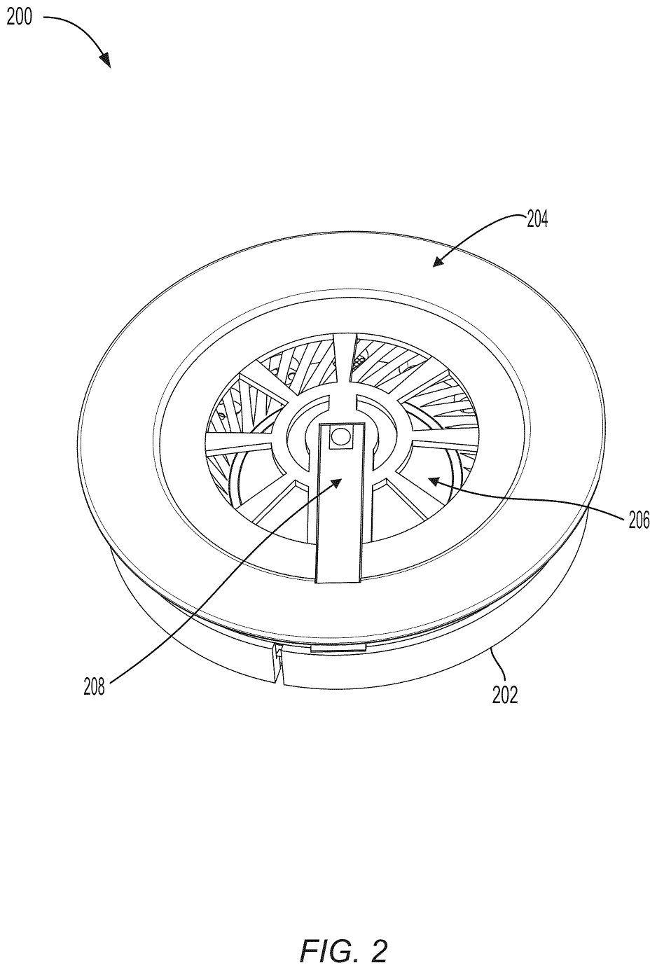

The speaker pocket 108 may be configured and sized to house a multi-layer speaker assembly 110. Example multi-layer speaker assemblies are described in more detail below with respect to FIGS. 2-6. In general, and as previously mentioned, due to inherent size and space constraints of helmets (size and space constraints of interior space 150 and/or speaker pocket 108), the size of the multi-layer speaker assembly 110 is necessarily limited. As is readily apparent in FIG. 1, an overly bulky and/or overly ridged speaker assembly positioned in speaker pocket 108 may undesirably protrude too far into interior space 150. Then, when the helmet 100 is worn by a user, the overly bulky and/or overly ridged speaker assembly will put too much pressure against the user's ear and will be uncomfortable over periods of sustained use. Additionally, a speaker assembly positioned in speaker pocket 108 that does not couple well to the ear canal of the user will suffer from poor acoustic performance. The provided multi-layer speaker assembly 110, described in more detail below, solves the aforementioned issues by providing a low-profile multi-layer speaker assembly that is comfortable for the user over a period of sustained usage while also providing improved acoustic properties.

FIG. 2 shows an example of a speaker 202 and speaker grille 204 configured to fit within a speaker pocket 108 of a helmet, according to certain embodiments. As described in more detail below, speaker 202 and speaker grille 204 form at least two layers (i.e., components) of the multi-layer speaker assembly. Speaker 202 and the attached speaker grille 204 may be sized to fit within the speaker pocket 108 shown in FIG. 1. The speaker 202 can be a speaker of any suitable type capable of generating audio signals that propagate outwards from the sound generating element 206 (i.e., the membrane) of the speaker 202. As described above with respect to FIG. 1, when the speaker 202 is positioned within a helmet, such as helmet 100, the sound generating element 206 may be aligned with an ear canal of the ear of the user such that audio signals generated by the speaker 202 propagate towards and into the ear canal of the user.

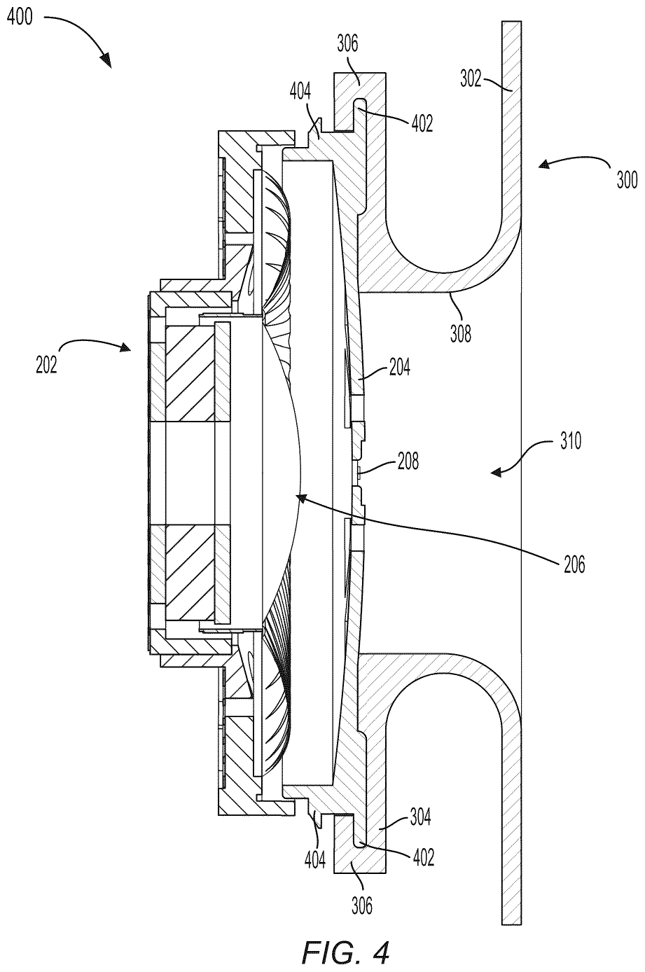

Also shown in FIG. 2 is a speaker grille 204. As described in more detail with respect to FIG. 4, speaker grille 204 may clip, snap, latch, and/or be glued onto the speaker 202 using clips, snaps, latches, or glue. Speaker grille 204 may be formed from a material such as, for example, a polypropylene (PP) material, thermoplastic material, polyethylene, 3D printed resin, metal, filament, and the like. In the case of a metal speaker grille, the metal material provides the added benefit of absorbing energy in the case, for example, of an accident. In these cases, the metal grille and speaker element may act as an additional damping element to further protect the wearer. Speaker grille 204 provides a physical protection layer for speaker 202 by protecting the speaker 202 from particles that may fall towards the speaker 202 and in particular, particles that may fall towards the sound generating element 206. Additionally, speaker grille 204 includes a mount 208 that provides a mounting location for accessories, such as one or more microphones. In example multi-layer speaker assemblies incorporating ANC functionality, a reference and/or error microphone may be mounted to mount 208. Further, and although mount 208 is illustrated in FIG. 2 being on a top side portion of the speaker grille 204 (i.e., a side of the speaker grille 204 facing away from the speaker 202), in some examples, mount 208 may be positioned at a different location, such as on an underside portion of the speaker grille 204 (e.g., a side of the speaker grille 204 facing toward the speaker 202).

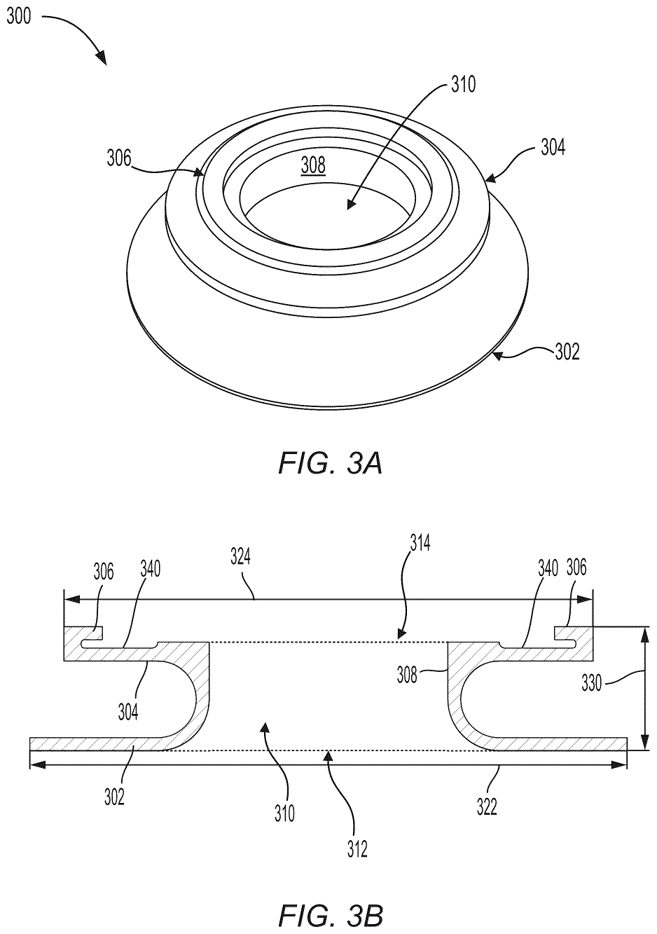

FIGS. 3A and 3B respectively show a perspective view and a cross-sectional side view of a polymer ring structure 300, according to certain embodiments. Polymer ring structure 300 is formed from a nonpermeable material, such as silicone, rubber, coated fabric, leather (e.g., protein leather), or any other thin, soft, and acoustically nonpermeable material. More specifically, the polymer ring structure 300 is nonpermeable and prevents a flow of air through the material. The nonpermeable material of the polymer ring structure enables an acoustically opaque structure thereby providing for passive noise reduction of noise due to blocking sound waves other than those emitted from the speaker. As such, in some embodiments, the polymer ring structure 300 may provide noise reduction functionality without the need for additional electronics (e.g., without the need for additional ANC controller and/or microphone components). Further, as compared to the material forming the speaker grille 204, as described with respect to FIG. 2, the nonpermeable material that forms the polymer ring structure 300 is soft and conformal. As a result, the conformal nature of the polymer ring structure (in combination with a speaker cover, described below) can improve the comfort of multi-layer speaker assemblies incorporating the polymer ring structure 300.

Polymer ring structure 300 includes first surface 302, second surface 304, and cylindrical wall 308 extending between the first surface 302 and the second surface 304. The first surface 302 and the second surface 304 may have a shape that matches the profile of a speaker and speaker grille, such as a circular shape to match the circular profile of the speaker 202 and speaker grille 204 described with respect to FIG. 2. The cylindrical wall 308 extending between the first surface 302 and the second surface 304 defines a cylindrical inner region 310 with openings 312, 314 on either end of the polymer ring structure 300 (i.e., an opening 312 in the first surface 302 and an opening 314 in the second surface 304). The first surface 302 may have a first diameter 322 defining a first circumference and the second surface 304 may have a second diameter 324 defining a second circumference. In some examples, the circumference of the first surface 302 may be larger than the circumference of the second surface 304. The larger circumference of the first surface 302 enables a larger surface area of the first surface 302, which is the surface that faces the ear of the user. The additional surface area can also provide improved comfort for the user. In some examples, and for manufacturing purposes, polymer ring structure 300 may be highly conformal and may easily be folded, manipulated, and/or compressed.

According to some examples, a larger circumference of the first surface 302 is not always required. For instance, the circumference of the first surface 302 may be the same and/or smaller than the surface of the second surface 304 depending on the particular use case and/or depending on the size of the respective speaker and/or speaker grille. In some examples, the first diameter 322 may be between 40 and 80 mm, and in one particular example, such as the example shown in FIGS. 3A and 3B, the first diameter 322 is 70 mm. The cylindrical inner region 310 can have a diameter that may be between 20 and 40 mm, and in one particular example, such as the example shown in FIGS. 3A and 3B, the diameter of the cylindrical inner region 310 is 30 mm.

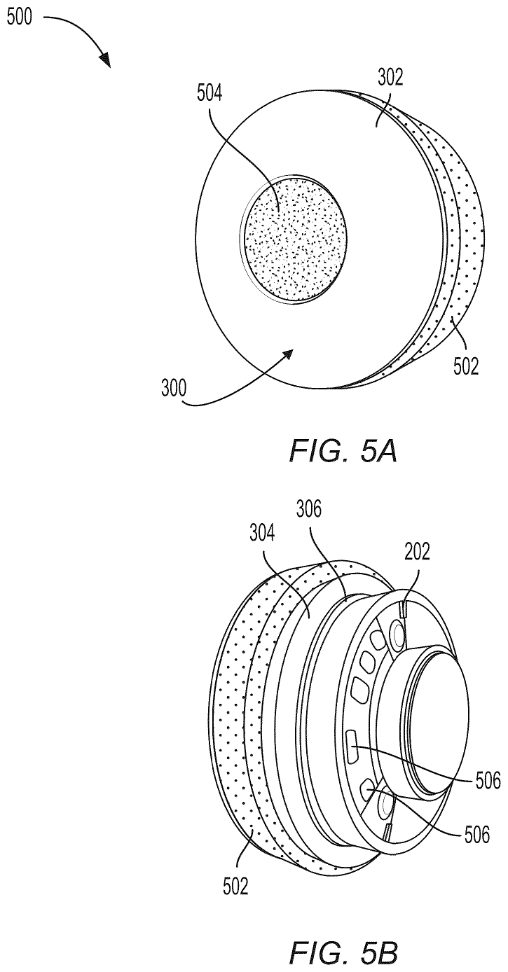

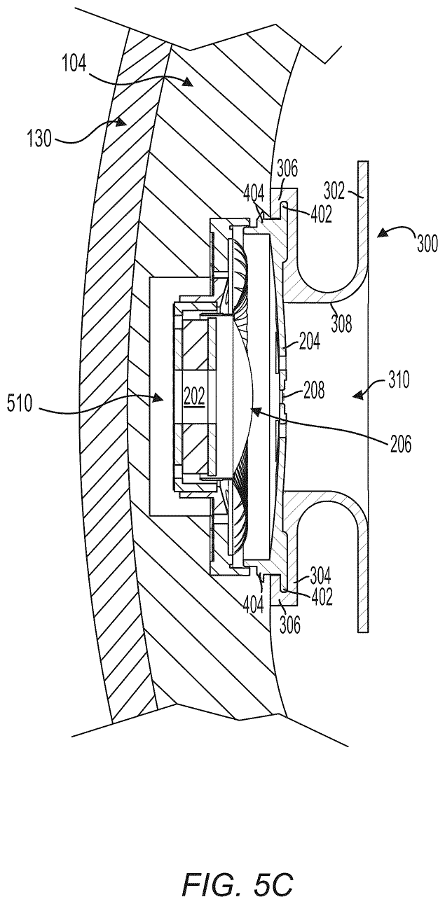

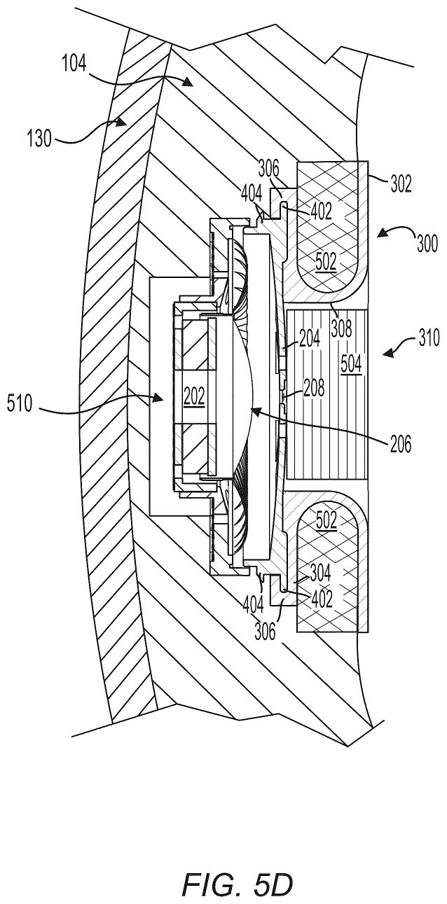

In some examples, the cylindrical inner region 310 can have a diameter that is the same as either the first surface 302 and/or the second surface 304. In these examples, the polymer ring structure 300 may be referred to as a “closed” structure as the outer rim of the polymer ring structure 300 (e.g., corresponding to the circumferences of the first surface 302 and/or the circumferences of the second surface 304) would no longer be open. Use of a “closed” polymer ring structure further improves the structural integrity of the multi-layer speaker assembly. In some examples, the polymer ring structure 300 has a first cylindrical inner region having a first circumference smaller than either the first surface 302 and/or the second surface 304 and defining a first cylindrical wall (e.g., corresponding to the cylindrical inner region 310) and a second cylindrical outer region (not shown) having a second circumference that is the same as either the first surface 302 and/or the second surface 304. In these examples, the polymer ring structure 300 may also be considered “closed” (e.g., by virtue of the second cylindrical outer region). A tube may surround the cylindrical inner region 310 in a space between the first cylindrical wall defined by the cylindrical inner region 310 and the second cylindrical outer region. In some examples, and for added comfort, the tube could be filled with a foam material, such as foam ring 502 discussed in more detail below with respect to FIG. 5. In addition, while the cylindrical inner region 310 needs to be acoustically tight/sealed with the corresponding speaker and speaker grille, the second cylindrical outer region does not need to be acoustical sealed. In some examples, the second cylindrical outer region may include perforations in the sidewall to improve the conformability of the structure and to reduce and/or eliminate undesirable tension on the ear of the wearer due to air inside the tube.

Polymer ring structure 300 also has a predetermined height 330. As mentioned above, due to size and space constraints, the size of a speaker and the associated multi-layer speaker assembly that may be used within a helmet is necessarily limited. As such, height 330 of polymer ring structure 300 is predetermined such that when the polymer ring structure 300 is mounted to a speaker and speaker grille, the resulting multi-layer speaker assembly does not protrude too far into the interior space of the helmet, such as interior space 150 of helmet 100. Height 330 may be in the range of 5 -15 mm, and in a particular example, height 330 may be between 10-12 mm. In one particular example, the multi-layer speaker assembly including speaker 202, speaker grille 204, and polymer ring structure 300 may be positioned inside speaker pocket 108 and is flush mounted or substantially flush mounted with the surface of the cheek piece 102 that contacts the user's face. Flush mounted, in this context, means the first surface 302 of the polymer ring structure 300 protrudes outwards just in front of the surface of the cheek piece 102 that contacts the user's face. In some examples, this can mean that the first surface 302 protrudes outwards with a height that is less than height 330. Substantially flush, in this context, means the first surface 302 of polymer ring structure 300 may be sit just behind (e.g., within and/or inside) the surface of the cheek piece 102 that contacts the user's face.

In some examples, height 330 may not be uniform across (e.g., with respect to) the first surface 302. In other words, portions of the first surface 302 may have a greater height than other portions of the first surface 302. In these examples, the polymer ring structure 300 may be considered non-symmetrical with respect to the first surface 302. In some examples where height 330 is not uniform with respect to the first surface 302, the first surface 302 can form a wedge shape where the first surface 302 would have less height at an upper portion of the first surface 302 corresponding to an upper portion of the pinna (e.g., the portion of the polymer ring structure 300 contacting and/near the helix of the ear) and more height at the lower portion of the first surface 302 corresponding to a lower portion of the pinna (e.g., the portion of the polymer ring structure contacting and/or near the lobe of the ear). Such a non-uniform height across the first surface 302 improves comfort for the user due to higher pressure points that are typically located in the upper regions of the pinna.

Polymer ring structure 300 also includes a raised lip 306 formed on the second surface 304. As described in more detail with respect to FIG. 4, raised lip 306 is sized to completely surround and abut against an outer circumference of the speaker grille 204. The raised lip 306, when elastically engaged around the speaker grille 204, forms an acoustic sealing between the polymer ring structure 300 and the speaker grille 204 and speaker 202. In some examples, a groove 340 may be formed in the second surface 304 to further strengthen the acoustic sealing as the outer circumference of the speaker grille 204 may sit in the groove 340. Although FIG. 3 is illustrated as including raised lip 306, as previously mentioned, inclusion of the raise lip 306 is not always required. For instance, the acoustic sealing may be formed by gluing the polymer ring structure 300 directly to the speaker grille 204. Importantly, the acoustic sealing in combination with the nonpermeable material of the polymer ring structure 300 enables formation of an acoustic waveguide in the cylindrical inner region 310 such that the polymer ring structure 300 directs propagation of sounds waves generated by the speaker 202 along a specific path through the cylindrical inner region 310 from the speaker 202 to the ear of the user. The acoustic waveguide thus enables control over the direction and intensity of the sound waves, preventing dispersion and improving clarity in the audio signals for the user. Additionally, it will be appreciated that in some examples, a partial acoustic sealing between the polymer ring structure 300 and the speaker grille 204 can still enable the formation of the acoustic waveguide. In other words, so long as the polymer ring structure 300 is substantially adhered to the speaker grille 204, the benefits described herein (e.g., the polymer ring structure 300 directing propagation of sounds waves generated by the speaker 202 along a specific path through the cylindrical inner region 310 from the speaker 202 to the ear of the user) may still be realized.

Additionally, it will be appreciated that while FIG. 3A shows polymer ring structure 300 as having a circular and smooth profile, polymer ring structure 300 may have different shaped profiles (e.g., square, rectangular, elliptical, and the like) and may include respective first and second surfaces that are not completely smooth/continuous. For instance, according to some examples, pressure points may occur at certain regions of the pinna of the ear of the user. In these cases, there may be a reduction of material forming the polymer ring structure 300 at such pressure point regions (e.g., reduced material on the first surface 302) to reduce a pressure and minimize discomfort so long as the cylindrical inner region 310 (or other shaped inner region) remains closed and respectively intact to maintain the acoustic waveguide.

Moreover, the polymer ring structure 300 of FIGS. 3A and 3B illustrates an “open” outer region (i.e., there is a gap formed between the first surface 302 and the second surface 304 around the outer portion of the cylindrical wall 308 hereinafter referred to as an “outer rim”). Leaving the outer rim open as shown in FIG. 3A, and 3B also increases the level of comfort for the user as the polymer ring structure 300 will conform and compress responsive to contact with the user's ear. In other example polymer ring structures, however, the outer rim may be “closed” such that there is no gap formed between the first surface 302 and the second surface 304.

FIG. 4 shows a cross-sectional side view of a multi-layer speaker assembly 400, according to certain embodiments. Beginning at the left side of FIG. 4, multi-layer speaker assembly 400 includes speaker 202. A speaker grille 204 is attached to the front surface of the speaker 202 (i.e., the surface of the speaker 202 from which sound is emitted). As shown in FIG. 4, the speaker grille 204 is sized to fit over the speaker 202. As previously mentioned with respect to FIG. 2, speaker grille 204 clip, snap, latch, and/or be glued onto the speaker 202 using clips, snaps, latches, or glue onto the speaker 202. Also shown in FIG. 4 are snaps 404. Snaps 404 may extend downwards from the outer circumference 402 of the speaker grille 204 and may be used to attach the whole multi-layer speaker assembly 400 to a PP layer incorporated into a front surface (e.g., surface contact the user's face) of the EPS. Snaps 404 enable the multi-layer speaker assembly 400 to be removable from the helmet.

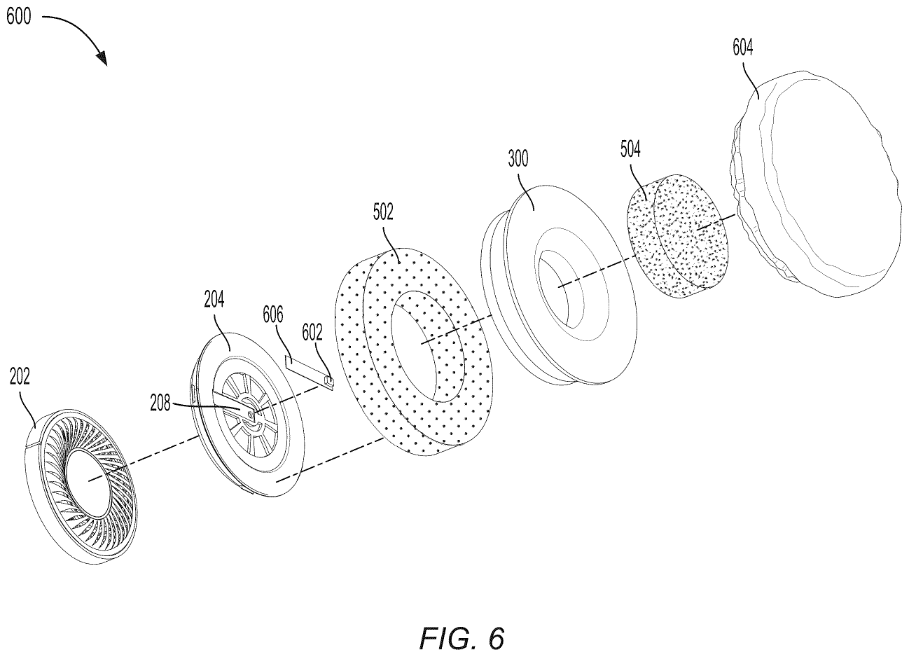

Also shown in multi-layer speaker assembly 400 is mount 208 on speaker grille 204 which provides a mounting location for additional accessories of the multi-layer speaker assembly 400, such as a microphone. The mount 208 may form a recessed channel of the speaker grille 204 such that a microphone may slide into the recessed channel (as shown in FIG. 6). Additionally, or alternatively, the microphone may attach to the mount 208 using an adhesive. Although only one mount (i.e., mount 208) is illustrated in FIG. 4, more than one mount may be provided in the multi-layer speaker assembly 400 and other components of the multi-layer speaker assembly 400 (such as polymer ring structure 300) may provide suitable mounting locations for additional microphones or accessories. One of ordinary skill in the art would recognize many variations, modifications, and alternatives.

Multi-layer speaker assembly 400 also includes the polymer ring structure 300. In particular, the polymer ring structure 300 of FIG. 3A has been flipped such that the second surface 304, including the raised lip 306, is fit around an outer circumference 402 of speaker grille 204. In this way, cylindrical inner region 310 is horizontally aligned with the sound generating element 206 of the speaker 202. Openings in either end of the polymer ring structure 300 (i.e., openings 312, 314 of FIG. 3B) enable sound waves to propagate from the sound generating element 206 toward the ear of the user (not shown) which would be positioned adjacent the first surface 302. As mentioned previously with respect to FIGS. 2 and 3A-3B, the acoustic sealing of the speaker 202 and speaker grille 204 using the polymer ring structure 300 enables formation of an acoustic waveguide in the cylindrical inner region 310 such that the polymer ring structure 300 directs propagation of sounds waves generated by the speaker 202 along a specific path through the cylindrical inner region 310 from the speaker 202 to the ear of the user.

The acoustic waveguide enables control over the direction and intensity of the sound waves, preventing dispersion and improving clarity in the audio signals for the user. In addition, the low-profile design of the multi-layer speaker assembly 400 improves the comfort for the user as the multi-layer speaker assembly (i.e., by virtue of a soft polymer material of polymer ring structure 300) which may otherwise cause undesirable pressure against the wearer's ear over a period of sustained usage. The waveguide could also be realized by forming a tunnel with the outside boarders of the polymer ring structure 300. In other words, the outside boarders of the polymer ring structure 300 corresponding, for example, to the cylindrical wall 308 (e.g., in a closed outer rim embodiment) may provide an acoustic tunnel that significantly reduces a noise level (e.g., ambient noise) inside the waveguide by utilizing sound-absorbing materials on its walls. Moreover, and in the case where the multi-layer speaker assembly 400 is clipped into the PP layer incorporated into a front surface (e.g., surface contact the user's face) of the EPS via snaps 404, the raised lip 306 can provide a sealing ring/layer between the PP and the multi-layer speaker assembly 400.

In some examples, and in addition to the described implementations for in-helmet audio systems, the described multi-layer speaker assembly may be implemented into headphones. For instance, the multi-layer speaker assembly 400 may form an over-ear and/or on-ear headphone assembly. In these examples, two multi-layer speaker assemblies may be connected (e.g., structurally and electronically) to provide an over-ear and/or on-ear headphone assembly for a user where a first multi-layer speaker assembly is used for one ear and a second multi-layer speaker assembly is used for the other ear. In these examples, the headphones incorporating the multi-layer speaker assembly may comprise appropriate circuitry to couple (e.g., wireless and/or a wired connection) to an electronic device, such as a smartphone, tablet, computer system, etc.

FIGS. 5A and 5B respectively show a front perspective view of a multi-layer speaker assembly 500 and a back perspective view of the multi-layer speaker assembly 500, according to certain embodiments. As mentioned above, example multi-layer speaker assemblies described herein, such as multi-layer speaker assembly 400 described with respect to FIG. 4, can include additional features and functionality (i.e., in addition to the speaker 202, speaker grille 204, and polymer ring structure 300 layers) to further improve the performance of in-helmet audio systems.

As shown in FIGS. 5A and 5B, the multi-layer speaker assembly 500 includes a variety of foam structures. For instance, a foam ring 502 is included and is positioned around an outer portion of the cylindrical wall 308 of the polymer ring structure 300. In addition, a foam insert 504 may be positioned inside the cylindrical inner region 310 of the polymer ring structure 300 (i.e., inside the acoustic waveguide) and attached to either the speaker grille 204, or an inner portion of the cylindrical wall 308 using a friction fit (e.g., by virtue of the similar sizing to the cylindrical inner region 310), glue, or the like. Foam ring 502 and foam insert 504 may each be formed from any suitable foam material such as polyethylene foam, ether-based polyurethane foam, sing-cell foam, memory-foam and the like, each having a defined acoustic impedance.

Each of the foam ring 502 and the foam insert 504 (herein after the “foam(s)”) having a defined acoustic impedance, provide a variety of additional benefits to the multi-layer speaker assembly 500. For example, the foam ring 502 that surrounds and abuts the outer portion of the cylindrical wall 308 provides support between the second surface 304 (i.e., the surface contacting the speaker grille 204) and the first surface 302 (i.e., the surface adjacent the user's ear). The added support may provide improved comfort to the user. In addition, the foam ring 502 can also have the added benefit of preserving the acoustic waveguide by blocking (i.e., absorbing) undesirable low frequency sounds from entering the acoustic waveguide as well as serving as a physical barrier to protect the polymer ring structure 300 from debris such as rainwater, snow, salt spray, bugs, and the like. Similarly, the foam insert 504 provides protection benefits to the multi-layer speaker assembly 500 such as protecting the sound generating element 206 of the speaker 202 (i.e., the membrane) from particles falling through the speaker grille 204 (which may otherwise cause undesirable rattling if particles are trapped on top of the sound generating element 206).

In addition to the structural and physical protective benefits of the above-described foam structures, the foam insert 504 also provides improved acoustic performance of the multi-layer speaker assembly 500, and in a particular example, for in-helmet audio systems incorporating active noise cancellation (ANC) functionality or passive noise reduction functionality. As previously mentioned, in-helmet audio systems incorporating ANC functionality may include at least one microphone (e.g., a reference and/or error microphone) installed on the speaker grille 204 using mount 208, and a controller may be communicatively coupled to the microphone(s) and the speaker 202 of the multi-layer speaker assembly 500. In some embodiments, the controller may be coupled to the speaker and/or the microphone(s) via a wireless connection (e.g., Bluetooth®) or a wired connection. For instance, the controller (not shown) may connect to the speaker 202 and/or microphone (not shown) using electrical connectors 506 positioned on a backside of the speaker 202. The microphone(s) receives acoustic signals and transmits such signals or representations of them to the controller, which executes audio processing instructions and/or the ANC instructions for audio playback and/or ANC using the speaker, wherein the controller relies on a known transfer function between the input sound signal detected from the microphone and the resulting sound produced by the speaker to “cancel” out and/or reduce/control the detected sound (i.e., creating an anti-phase cancellation/control effect).

Inclusion of the foam insert 504 improve the phase response of the secondary path in ANC systems. As previously mentioned, the secondary path may refer to the acoustic transfer function between the speaker 202, which generates the anti-phase cancellation signal, and the error microphone. More specifically, the foam(s) having an acoustic impedance lower than an acoustic impedance of the polymer ring structure 300 improve the low frequency portion of the secondary path in such a way that the phase frequency response of the secondary path, particularly at low frequencies, is smoother and less dynamic thereby leading to improved ANC performance, especially in the bass region.

In addition, and focusing specifically on the foam insert 504, the inventors have determined that the denser the foam insert 504, leading to a higher acoustic impedance, the better (i.e., shallower, flatter, less dynamic, smoother) the secondary path phase frequency response; however, the higher density foam(s) can result in a negative impact to in-helmet audio systems in terms of comfort. As a result, in some examples of the multi-layer speaker assembly 500, the foam insert 504 can include multiple layers such as two separate layers of foam each having different densities, where a first layer of the foam insert installed directed at the speaker grille is denser than a second layer of the foam insert installed inside the acoustic waveguide. The multiple layers may be formed from the same or different foam materials that may be connected together using, for example, an adhesive.

FIGS. 5C and 5D each show a side view of a multi-layer speaker assembly positioned within an inner protective layer, according to certain embodiments. As illustrated in FIG. 5C, the multi-layer speaker assembly can be positioned partially within the interior protective layer 104 whereby the speaker 202 is mounted within the interior protective layer 104 and the polymer ring structure 300 protrudes out of the interior protective layer 104 in a direction towards the ear of the user. As illustrated in FIG. 5D, the multi-layer speaker assembly can be positioned completely within the interior protective layer 104 (e.g., flush mounted as described with respect to FIG. 3. In the example of FIG. 5D, the multi-layer speaker assembly also includes foam insert 504 and foam ring 502. It may be appreciated, however, that the foam insert 504 and foam ring 502 may be included in the multi-layer speaker assembly shown in FIG. 5C.

In various embodiments, the helmet can be the helmet 100 of FIG. 1 having outer shell 130. The multi-layer speaker assembly of FIGS. 5C and 5D can be any of the multi-layer speaker assemblies described herein such as multi-layer speaker assembly 400 described with respect to FIG. 4, multi-layer speaker assembly 500 described with respect to FIGS. 5A and 5B, or the multi-layer speaker assembly 600 described with respect to FIG. 6, for example. Further, and as described with respect to FIG. 4, multi-layer speaker assembly of FIGS. 5C and 5D can include snaps 404, which may be used to attach the whole multi-layer speaker assembly to the interior protective layer 104. In some embodiments, the multi-layer speaker assembly may be removably secured within the interior protective layer 104 by way of a press-fit or form fit or using Velcro.

In some embodiments, the interior protective layer 104 may include a holder (not shown) within the interior protective layer 104 that receives the multi-layer speaker assembly. In some examples, the holder can be positioned within the speaker pocket 108. The holder can be formed from an elastomeric or rubber material, plastic, or any other suitable material. The holder can secure (e.g., hold) the multi-layer speaker assembly in the interior protective layer 104. In some examples, securement of the multi-layer speaker assembly may be facilitated by snaps 404 snapping into radially protruding elements of the holder. In some examples, the holder can clamp around an outer periphery of the multi-layer speaker assembly (e.g., by virtue of a rubber material) to secure the multi-layer speaker assembly. In some embodiments, the holder can have a shape that is similar to (or matches) a profile of the multi-layer speaker assembly or a profile of the speaker pocket 108. Inclusion of a holder may enable the multi-layer speaker assembly to be mounted to or detached from the interior protective layer 104. In some examples, the described holder can be bonded to an inner surface of the speaker pocket 108 of the interior protective layer 104 using a suitable bonding material and/or via a form/friction fit.

As illustrated in FIGS. 5C and 5D, a space 510 can be formed between a rear/back side (e.g., a side opposite the ear of the user) of the speaker 202 and the interior protective layer 104 when the multi-layer speaker assembly and helmet are in an assembled state. In some embodiments, space 510 may be referred to as a “rear chamber.” In various applications, undefined sealing of the rear chamber can cause large variations of the loudspeaker frequency response at the ear. Besides unpleasant sound coloration this may also cause left to right sound pressure mismatch causing great annoyance to listeners. Undefined sealing of the rear chamber can render a complete transducer assembly of the speaker 202 unusable for static feedback (FB) and feedforward (FF) active noise cancellation (ANC) techniques. Static ANC with a fixed filter set for FF or FB ANC relies on a known transfer function from the loudspeaker to the ear or at least to the FB microphone. Undefined sealing of the rear chamber can cause large variations in these transfer functions. Such variations can drastically reduce ANC, cause actual noise boost instead of cancellation, or even feedback instability. The latter may result in feedback loop oscillation generating loud whistling or rumbling noises. These can cause a shock or fear reaction of a wearer of a helmet equipped with such an ANC system. As a result, accidents can happen, for example in traffic situations.

Embodiments of the present disclosure address the aforementioned problems associated with undefined sealing of the rear chamber (e.g., space 510). As previously described, polymer ring structure 300 may include raised lip 306 configured to surround and abut the outer circumference 402 of the speaker grille 204 to form an acoustic seal between the polymer ring structure 300 and the speaker 202. The formation of the acoustic seal facilitates the propagation of sounds waves generated by the speaker 202 along a specific path through the cylindrical inner region 310 from the speaker 202 to the ear of the user. In addition to the acoustic sealing between the polymer ring structure 300 and the speaker 202 and in the context of FIGS. 5C and 5D, polymer ring structure 300 may also form an acoustic sealing with the interior protective layer 104. In the implementation of FIG. 5C, the acoustic sealing may be defined at the interface between the raised lip 306 and the interior protective layer 104, and in the implementation of FIG. 5D, the acoustic sealing may be defined at the interface between first surface 302 and the interior protective layer 104. Advantageously, the acoustic sealing between the polymer ring structure 300 and the interior protective layer 104 can facilitate an acoustic decoupling of the space 510 from the sound generating element 206 of the speaker 202 thereby acoustically isolating sound emitted from the rear of the speaker 202 from sound emitted from the front of the speaker 202.

FIG. 6 shows an exploded view of a multi-layer speaker assembly 600, according to certain embodiments. The exploded view of multi-layer speaker assembly 600 shares similar features and elements described above with respect to FIGS. 2-5. The various elements of FIGS. 2-5 illustrated in exploded view (including newly added elements) are illustrated in the planes in which the various elements are disposed. The multi-layer speaker assembly 600 includes speaker 202 configured to generate audio signals that may be received by the ear of the user, and speaker grille 204 configured to attach onto the front surface of the speaker 202 and provide both protection for speaker 202 as well as a mounting location, using mount 208, for a microphone, such as microphone 602. The microphone 602 includes the flexible printed circuit board (PCB) 606 on which microphone 602 is mounted. The microphone 602 and associated PCB 606 connects to electronics (e.g., audio electronics, in-helmet audio electronics, controllers, etc.) either directly (e.g., via a wireless connection) or through a driver PCB (not shown). Microphone 602 mounted on PCB 606 can be located on top of speaker grille 204 and mounted to mount 208, as shown in FIG. 6. In some examples, the PCB 606 including the mounted microphone 602 may be mounted underneath the speaker grille 204 (e.g., between the speaker 202 and speaker grille 204). In other examples, the PCB 606 including the mounted microphone 602 can be positioned off (e.g., outside) both the speaker 202 and the speaker grille 204. For instance, the microphone 602 and PCB 606 can be positioned inside the acoustic waveguide of polymer ring structure 300. In some examples, the microphone 602 and PCB 606 may be positioned to be “floating” between the speaker 202 and the speaker grille 204 by virtue of clipping the flexible PCB 606 to the side of the speaker 202 where the PCB extends over the speaker 202 but is not physically contacting the speaker 202 or the speaker grille 204.

Multi-layer speaker assembly 600 also includes foam ring 502, polymer ring structure 300 and foam insert 504. As described with respect to FIGS. 4 and 5A-5B, foam ring 502 may surround and abut against an outer portion of cylindrical wall 308 of the polymer ring structure 300 and foam insert 504 may be inserted into the cylindrical inner region 310 (i.e., the acoustic waveguide). Although not visible in FIG. 6, polymer ring structure 300 may include raised lip 306 configured to surround and abut the outer circumference 402 of the speaker grille 204 to form an acoustic seal. Multi-layer speaker assembly 600 also includes cover 604. Cover 604 may be any acoustically transparent material and may provide additional cushioning or padding to further improve the comfort of the multi-layer speaker assembly 600. Cover 604 may cover first surface 302 of the polymer ring structure 300. More specifically, cover 604 provides a barrier layer for the multi-layer speaker assembly 600 so that the ear of the user does not directly contact the polymer ring structure 300. As mentioned above, the cover 604 is formed from an acoustically transparent material meaning little to no sound waves generated by the speaker 202 are absorbed or otherwise disrupted by the cover 604. In a particular example, a noise reduction coefficient of the cover 604 should be zero or as close to zero as possible.

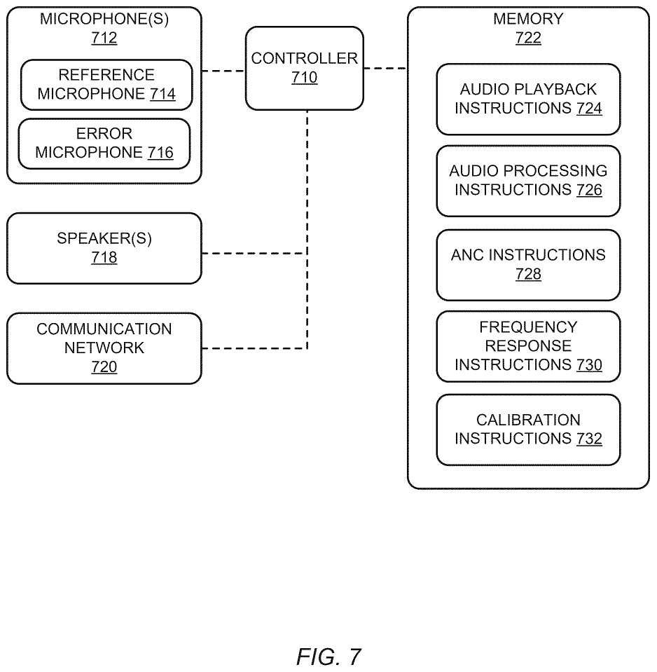

Referring now to FIG. 7, FIG. 7 shows an example arrangement of various components making up an in-helmet audio system. The in-helmet audio system is capable of generating, receiving, and processing audio signals for implementing aspects of an ANC system according to certain embodiments of the disclosure. The in-helmet audio system includes a controller 710. Controller 710 may include one or more microprocessor(s) or other processing device(s) like a digital signal processor (DSP). Controller 710 may, for example, be an SOC (system on chip) comprising hardware interfaces for attached components like for example microphone(s) 712, speaker(s) 718, and communication network 720. The overall system as shown in FIG. 7, also includes a memory device 722 or other non-transitory computer readable medium for storing and executing computer executable instructions and data. The computer executable instructions can include audio playback instructions 724, audio processing instructions 726, ANC instructions 728, and frequency response instructions 730. In some cases, the memory device 722 may be included in one or more system component such as, for example, the controller 710. Other components, for example the speaker(s) 718 or microphone(s) 712, may also comprise memory device(s) or other means to store certain information as will be described below.

Memory device(s) on the speaker(s) 718 or microphone(s) 712 may comprise a suitable interface to the controller 710, such as a wired or wireless connection. In case of a wired connection, connection wires may at least partly be shared with wires utilized for a speaker driving signal. For example, an electronic storage device or electronic component may share a common wire with the speaker(s) 718 that provides a common signal, for example an electrical reference voltage (e.g., signal ground). Memory device(s) on the speaker(s) 718 or microphone(s) 712 may, for example, store information about the speaker(s) 718 or microphone(s) 712 or a helmet for which these components are configured. Memory device(s) on the speaker(s) 718 or microphone(s) 712 may also support a wireless connection for exchange of data or information with corresponding devices, like for example smartphones or other computing devices. An actual implementation of the exemplary audio system of FIG. 7 may comprise further components, including batteries, loudspeakers, sensors, memory devices, cable harnesses and connectors. A helmet audio system may be part of a larger system providing additional functionality for a helmet.

Continuing with FIG. 7, the audio system may be implemented with various interconnected parts or sub-assemblies. For example, the controller 710 may be communicatively coupled to one or more other devices, such as one or more microphone(s) 712, one or more speakers(s) 718, or a communication network 720. The controller 710 may be connected to such devices by way of any suitable communication link, such as wired connection(s), including connection(s) established by USB or similar ports or protocols, and/or wireless connection(s), such as Wi-Fi, Bluetooth®, or similar signaling methods. Microphone(s) 712 may include reference microphone 714 and/or error microphone 716. Microphone(s) 712 receive acoustic signals and transmit such signals or representations of them to the controller 710, which executes the audio processing instructions 726 and/or the ANC instructions 728. More specifically, the reference microphone 714 may be configured to detect noise in the in-helmet audio system such as ambient noise from the environment (e.g., wind, external voices, traffic noise, etc.), and the error microphone 716 may be configured to detect residual noise present in the in-helmet audio system after generation of the anti-phase cancellation signal, generated, for example, in response to execution of the ANC instructions 728. Communication network 720 may allow the controller 710 to communicate with other devices, for instance, through Bluetooth®, such that the in-helmet audio system can receive audio signals such as voice communications, voice prompts and music from other devices.

The various components illustrated in FIG. 7 including microphone(s) 712, speaker(s) 718, communications network 720, controller 710, and memory 722 may be arranged for operation with any of the multi-layer speaker assembly configurations described herein, including all examples described with respect to FIGS. 1-6. Certain types of speaker(s) 718 in certain helmets may require specific signal processing for audio playback and ANC. Especially in cases of multi-layer speaker assemblies provided as aftermarket accessory for certain helmets, it may be required to adapt signal processing in an audio system (as in FIG. 7) to the specific speaker(s) 718 and/or helmet. To enable audio playback and ANC capabilities, the speaker(s) 718 may emit sound waves from a sound generating element of the speaker(s) 718 to the ear of the user. The sounds emitted from the speaker(s) 718 may be generated based on execution of the audio playback instructions 724 and ANC instructions 728 stored in a memory device 722.

As previously mentioned, microphone(s) 712 and/or speaker(s) 718 may in some cases provide an interface that allows retrieval of information about the respective microphone(s) 712 and/or speaker(s) 718 and/or a helmet, for example by the controller 710. For instance, the speaker(s) 718 may comprise an electrical connection that allows sensing of a parameter like a resistance value related to specific speaker and/or helmet types. Certain ranges of resistance values may be associated with such information. The resistance value may be an electrical parameter of a speaker component, like for example a voice coil of the speaker(s) 718. The resistance value may also be related to a resistor located somewhere on the speaker(s) 718 or on a cable or connector of the speaker(s) 718. Certain speaker(s), microphone(s), and/or helmet types may be identified based on a resistance value or value range, or other electrical or physical parameter received from the speaker(s) 718. In yet another example, the speaker(s) 718 may comprise a memory device (not shown) that stores and provides information related to the speaker(s) 718 and/or a helmet to which any of the components belong or for which these components have been designed. The controller 710 may read such information and apply corresponding audio playback instructions 724, audio processing instructions 726, ANC instructions 728 and/or frequency response instructions 730 within signal handling and or processing for audio playback and/or ANC.

Audio processing instructions 726 may generally provide programs and/or parameters for processing of an audio signal, for example a playback signal prior to application to speaker(s) 718 or a microphone signal receiving from microphone(s) 712. Audio processing instructions 726 may include analog to digital conversion programs or parameters for converting audio received from microphone(s) 712 into a format amenable for processing. For instance, audio processing instructions 726 may be executed by the controller 710 in response to operations determined through execution of the ANC instructions 728 or frequency response instructions 730 to enable determination of a speaker transfer function and applying specific compensation functions for the loudspeaker transfer function. Other programs may also be included in audio processing instructions 726 such as noise filtration or equalization programs.

ANC instructions 728 may include or relate to programs or parameters for processing microphone signal(s) received by the microphone(s) 712, recording ambient noise, frontal sound and/or rear sound from speaker(s) 718, or generating noise cancelling signals, anti-phase cancellation signals, noise control signals, and/or distortion compensation signals for output by and/or to the speaker(s) 718. ANC instructions 728 may, for example, include information about signal processing paths and methods (i.e., information about the primary and/or secondary paths), representations of filter transfer functions or parameters for other linear or nonlinear signal processing steps like inversion, compression or limitation. The ANC instructions 728 may be executed by the controller 710 to generate and cause the speaker(s) 718 to emit acoustic waves for reducing or cancelling ambient noise detected from the microphone(s) 712 and/or for reducing distortion(s) of the speakers(s) 718. Execution of ANC instructions 728 may include application of a filter transfer function to a microphone signal from a microphone(s) 712 as well as any other suitable processing steps, for example signal inversion or signal compression, to receive a processed microphone signal. The processed microphone signal may subsequently be applied to the speaker(s) 718 as speaker driving signal or added to a speaker driving signal to become a signal component of the speaker driving signal.

Frequency response instructions 730 may be related to audio processing instructions 726 in that they may provide information associated with the speaker(s) 718 and/or a helmet in which the speaker(s) 718 and/or the multi-layer speaker assembly may be installed. Frequency response instructions 730 may also provide processing parameters required by audio processing instructions 726. Frequency response instructions 730 may also utilize audio processing instructions 726 to provide certain functionality. Frequency response instructions 730 may comprise programs for modifying the audio signals output through the speaker(s) 718 in combination with audio processing instructions 726. Certain multi-layer speaker assembly configurations may cause the speaker(s) 718 to have a certain acoustic profile. The frequency response instructions 730 may be executed by the controller 710 to identify the acoustic profile and to appropriately boost or attenuate particular frequency ranges of an output signal of the speaker(s) 718 in combination with audio processing instructions 726. In one example, to identify the acoustic profile of speaker(s) 718 in a given helmet, frequency response instructions 730 may comprise a measurement routine that determines specific aspects of a transfer function of the speaker(s) 718 like a sound pressure level or phase at one or more frequencies. Frequency response instructions 730 may, for example, invoke audio playback instructions 724 to provide a test signal for measurement or determination of aforementioned aspects of the speaker transfer function.

Furthermore, frequency response instructions 730 may invoke certain processing steps provided by audio processing instructions 726 like analog to digital conversion programs for converting audio received from microphone(s) 712 to a digital domain and processing the microphone signal to determine desired aspects of the transfer function of the speaker(s) 718. Based on determined aspects of the transfer function of the speaker(s) 718, frequency response instructions 730 may provide processing parameters required by audio processing instructions 726 to compensate for certain acoustic characteristics of the transfer function of the speaker(s) 718.

Memory 722 can also include calibration instructions 732. Calibration instructions 732 may include or relate to programs or parameters for calibrating one or more of the audio playback instructions 724, audio processing instructions 726, ANC instructions 728, or frequency response instructions 720. For example, calibration instructions 732 may leverage one or more adaptive filters (e.g., electronic filters designed to adjust in real-time to changing noise patterns) and/or algorithms to optimize the generation of acoustic waves (e.g., ensure precise phase and amplitude alignment) of the anti-noise signals for reducing or cancelling ambient noise detected from the microphone(s) 712 and/or for reducing distortion(s) of the speakers(s) 718. Such calibration algorithms may further employ one or more machine learning models, trained on historical noise data, to enable the system to learn and predict noise profiles over time. For example, calibration instructions 732 can provide instructions to analyze noise data captured in controlled settings. Such noise data may be used to train a machine learning model, to associate the noise data with historical and labeled noise data. The trained machine learning model can then predict the “best” anti-noise signal to reduce and/or cancel the noise data by identifying and counteracting specific noise frequencies and patterns. Such calibration techniques thus improve performance of ANC functionality in complex and variable acoustic environments.

The foregoing description of some examples has been presented only for the purpose of illustration and description and is not intended to be exhaustive or to limit the disclosure to the precise forms disclosed. It will be evident that numerous modifications and adaptations thereof will be apparent to those skilled in the art without departing from the broader spirit and scope of the disclosure.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

That which is claimed is:

1. A speaker assembly comprising:
a polymer ring structure comprising:
a first surface;
a second surface;
a cylindrical wall extending between the first surface and the second surface; and
an opening extending through the first surface, the cylindrical wall and the second surface, wherein the opening defines a cylindrical inner region of the polymer ring structure; and
a speaker grille attached to a front side of a speaker, wherein the second surface of the polymer ring structure is coupled to the speaker grille to form an acoustic seal between the speaker grille and the polymer ring structure.

2. The speaker assembly of claim 1, further comprising an acoustically transparent material covering the first surface of the polymer ring structure.

3. The speaker assembly of claim 1, wherein the cylindrical inner region defines an acoustic waveguide.

4. The speaker assembly of claim 1, further comprising:
a foam ring surrounding and abutting against an outer portion of the cylindrical wall between the first surface and the second surface of the polymer ring structure; and

5. The speaker assembly of claim 1, further comprising:
a foam insert positioned inside the cylindrical inner region of the polymer ring structure and circumferentially abutting against an inner portion of the cylindrical wall.

6. The speaker assembly of claim 5, wherein the foam insert is coupled to the speaker grille using an adhesive.

7. The speaker assembly of claim 5, wherein the polymer ring structure is characterized by a first acoustic impedance and wherein the foam insert is characterized by a second acoustic impedance, wherein the first acoustic impedance is greater than the second acoustic impedance.

8. The speaker assembly of claim 4, wherein the foam ring provides support between the first surface of the polymer ring structure and the second surface of the polymer ring structure, and wherein the foam ring is characterized by an acoustic impedance that is less than an acoustic impedance of the polymer ring structure.

9. The speaker assembly of claim 1, wherein the polymer ring structure comprises a nonpermeable material that prevents sound waves generated by the speaker from exiting the polymer ring structure.

10. The speaker assembly of claim 1, wherein a circumference of the cylindrical wall is smaller than a circumference of the second surface.

11. The speaker assembly of claim 1, further comprising:
a raised lip on the second surface, wherein the raised lip is positioned around an outer circumference of the speaker grille and forms a seal around the outer circumference of the speaker grille to acoustically seal the front side of the speaker within the cylindrical inner region.

12. The speaker assembly of claim 1, wherein the speaker grille includes at least one microphone mounted to the speaker grille and configured to detect a noise present in the cylindrical inner region.

13. A speaker assembly comprising:
a polymer ring structure comprising:
a first surface;
a second surface;
a cylindrical wall extending between the first surface and the second surface; and
an opening extending through the first surface, the cylindrical wall and the second surface, wherein the opening defines a cylindrical inner region of the polymer ring structure;
a speaker grille attached to a front side of a speaker, wherein the second surface of the polymer ring structure is coupled to the speaker grille to form an acoustic seal between the speaker grille and the polymer ring structure;
at least one microphone mounted to the speaker grille and configured to detect a noise present in the cylindrical inner region; and
a controller communicatively coupled to the at least one microphone and the speaker and configured to receive sound wave information associated with the noise and to execute signal processing instructions to generate audio playback signals through the speaker for active cancellation of the noise.

14. The speaker assembly of claim 13, wherein the controller is integrated with an external computing device, and wherein the controller is communicatively coupled to the at least one microphone and the speaker.

15. A helmet comprising:
an interior protective layer of the helmet having a speaker pocket formed in the interior protective layer; and
a speaker assembly housed inside the speaker pocket of the interior protective layer, the speaker assembly comprising:
a polymer ring structure comprising:
a first surface;
a second surface;
a cylindrical wall extending between the first surface and the second surface; and
an opening extending through the first surface, the cylindrical wall and the second surface, wherein the opening defines a cylindrical inner region of the polymer ring structure; and
a speaker grille attached to a front side of a speaker, wherein the second surface of the polymer ring structure is coupled to the speaker grille to form an acoustic seal between the speaker grille and the polymer ring structure.

16. The helmet of claim 15, wherein the speaker assembly is detachable from the helmet.

17. The helmet of claim 15, wherein the speaker assembly is substantially flush mounted with a surface of the interior protective layer of the helmet that contacts a user's ear, such that an acoustic waveguide is formed inside the cylindrical inner region between the speaker assembly and the user's ear from a partial pressure applied from the helmet on the user's ear.

18. The helmet of claim 15, wherein the speaker assembly further comprises:
a foam ring surrounding and abutting against an outer portion of the cylindrical wall between the first surface and the second surface of the polymer ring structure; and
a foam insert positioned inside the cylindrical inner region of the polymer ring structure and circumferentially abutting against an inner portion of the cylindrical wall.

19. The helmet of claim 15, wherein the polymer ring structure comprises a nonpermeable material that prevents sound waves generated by the speaker from exiting the polymer ring structure.

20. The helmet of claim 15, wherein the polymer ring structure further comprises:
a raised lip on the second surface, wherein the raised lip is positioned around an outer circumference of the speaker grille and forms a seal around the outer circumference of the speaker grille to acoustically seal the front side of the speaker within the cylindrical inner region.
